(19) United States
(12) Patent Application Publication
(10) Pub. No.: US 2017/0054596 A1
(43) Pub. Date: Feb. 23, 2017

(54) INTEGRATED INTERNET ACCESS ROUTER

(71) Applicant: KLAS TECHNOLOGIES LIMITED, Dublin (IE)

(72) Inventors: Frank MURRAY, Dublin (IE); Cathal DALY, Dublin (IE); Cian MASTERSON, Dublin (IE)

(21) Appl. No.: 15/238,744

(22) Filed: Aug. 17, 2016

Related U.S. Application Data
(60) Provisional application No. 62/206,601, filed on Aug. 18, 2015.

(51) Int. Cl. H04L 12/24; H04L 12/773

(52) U.S. Cl. CPC H04L 41/0803; H04L 45/60

(57) ABSTRACT

An integrated access router includes a modem for communicating with a wireless network. The integrated access router also includes a cellular gateway, comprising a switch for routing data via the modem. The integrated access router also includes a server comprising one or more processors, one or more computer-readable tangible storage devices, and program instructions stored on at least one of the one or more storage devices for execution by at least one of the one or more processors. The program instructions include a primary networking operating system for providing networking and communication capabilities via an Ethernet connection. The program instructions further include a secondary networking operating system for extending the capabilities of the primary operating system and providing networking and communication capabilities via a non-Ethernet connection by serving as an intermediary between the primary networking operating system and an underlying server operating system.

### CROSS-REFERENCE TO RELATED APPLICATION

This application claims priority from U.S. Patent Application No. 62/206,601 filed on Aug. 18, 2015, which is incorporated by reference herein in its entirety.

### BACKGROUND

Internet-enabled devices such as laptop computers, smartphones, and tablet computers are an integral part of everyday life for many people. Such devices are commonly used to communicate with others and to access a variety of products and services over the Internet, both for business as well as for entertainment purposes. For example, a tablet computer may be used to send an email, watch a streaming movie, or shop at an online retailer website. As such, Internet access availability is highly valued. Without Internet access, people may not be able to use such devices to communicate with one another or to access the products and services that may be relied on.

Because of the value of Internet access availability, business owners may increase customer satisfaction, which may result in increased revenue and market share, by offering Internet access to customers. For example, an owner or operator of a transportation service such as a bus or rail operator may increase a rider's satisfaction by offering Internet access to the rider while in transit. Solutions such as a Cisco Router exist for providing Internet access in a stationary location such as a coffee shop or a library. However, such solutions alone may not be reliable when deployed in a moving environment such as a train. Moreover, solutions exist to provide a rider with Internet access while in transit on a rail. For example, the ICOMERA X6 provides Internet access to passengers on a train. However, existing solutions rely on proprietary networking hardware which may have limited management tools and may be difficult and costly to configure and to maintain.

### SUMMARY

The present subject matter relates to an integrated access router, including a modem for communicating with a wireless network. The integrated access router may include a cellular gateway. The cellular gateway may comprise or consist of a switch for routing data via the modem. The integrated access router may include a server. The server may comprise or consist of one or more processors, one or more computer-readable tangible storage devices, and/or program instructions stored on at least one of the one or more storage devices for execution by at least one of the one or more processors. The program instructions may include a primary networking operating system for providing networking and communication capabilities via an Ethernet connection. The program instructions may further include a secondary networking operating system for extending the capabilities of the primary operating system and providing networking and communication capabilities via a non-Ethernet connection by serving as an intermediary between the primary networking operating system and an underlying server operating system.

According to the present subject matter, a computer program product may also be provided and may include one or more computer-readable tangible storage devices, and program instructions stored on at least one of the one or more storage devices. The program instructions include a primary networking operating system for providing networking and communication capabilities via an Ethernet connection. The program instructions further include a secondary networking operating system for extending the capabilities of the primary operating system and providing networking and communication capabilities via a non-Ethernet connection by serving as an intermediary between the primary networking operating system and an underlying server operating system.

The present subject matter may be a system for routing network data includes one or more processors, one or more computer-readable tangible storage devices, and/or program instructions stored on at least one of the one or more storage devices for execution by at least one of the one or more processors. The program instructions may include a primary networking operating system for providing networking and communication capabilities via an Ethernet connection. The program instructions may also include a secondary networking operating system for extending the capabilities of the primary operating system and providing networking and communication capabilities via a non-Ethernet connection by serving as an intermediary between the primary networking operating system and an underlying server operating system.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example system for providing Internet access in a moving environment.

FIG. 2 illustrates an example integrated Internet access router illustrated in FIG. 1.

FIG. 3 illustrates an example front panel of the example router illustrated in FIG. 2.

FIG. 4 illustrates an example rear panel of the example router illustrated in FIG. 2.

FIG. 5 illustrates a block diagram of the example router illustrated in FIG. 2.

FIG. 6 is a schematic diagram of an example computer for implementing the example server of FIG. 5.

### DETAILED DESCRIPTION

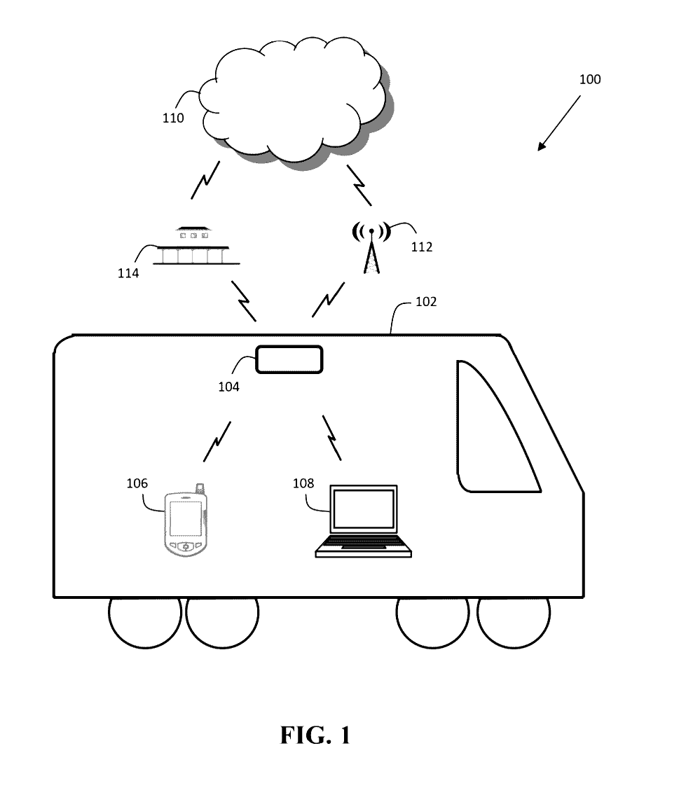

FIG. 1 illustrates a system 100 for providing Internet access in a moving environment, such as in a train 102. It should be appreciated that, although a train 102 is illustrated, the system 100 may similarly be deployed in other suitable moving environments where Internet access may be desirable, such as in a bus, in an airplane, and so on.

System 100 includes an integrated Internet access router 104 configured to provide one or more computing devices, such as a smartphone 106 or a laptop computer 108, with access to the Internet 110. It should be appreciated that although the smartphone 106 and the laptop computer 108 are illustrated as being in wireless communication with the integrated Internet access router 104, these or other computing devices may also communicate with integrated Internet access router 104 via a wired connection.

In one example, system 100 may further include a switch (not shown) in communication with the integrated Internet access router 104. The switch may be positioned in a second train compartment or at any second location in order to provide additional computing devices with access to the Internet 110 via the integrated Internet access router 104 when the additional computing devices may not be within range of communicating with integrated Internet access router 104 directly.

In order to facilitate a connection to the Internet 110 while the train 102 is in motion, the integrated Internet access router 104 is configured to leverage a cellular network 112 such as a 3G, 4G, or an LTE network. In one example, while the train 102 is stationary at a train station 114 or another location having a Wi-Fi network, the integrated Internet access router 104 may leverage the Wi-Fi network of the train station 114 in order to facilitate a connection to the Internet 110.

It should be appreciated that, although the integrated Internet access router 104 is described as functioning to provide Internet access to computing devices, the integrated Internet access router 104 may also be leveraged for other purposes. For example, the integrated Internet access router 104 may be used to provide media and other entertainment content to passengers of the train 102. The integrated Internet access router 104 may also be used to provide location-based services such as a hotel-booking feature and advertising features. The integrated Internet access router 104 may also be used to facilitate security features on the train 102 such as video surveillance.

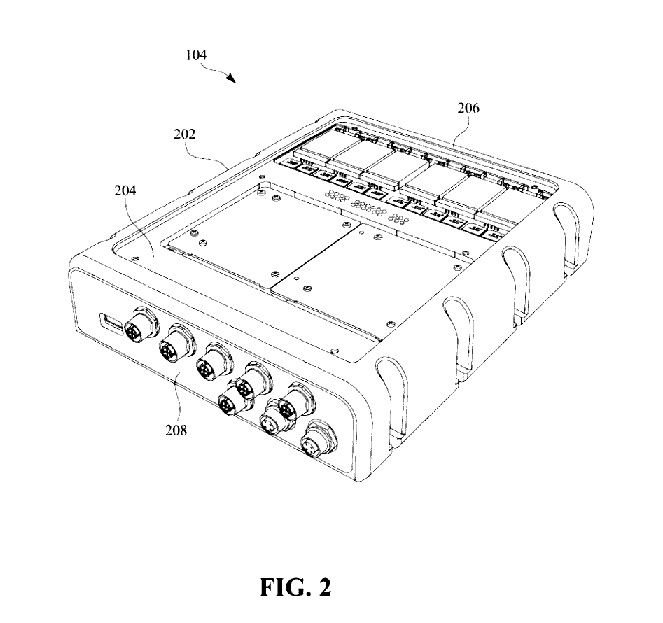

FIG. 2 illustrates an example integrated Internet access router (hereinafter referred to as “router”) 104 of FIG. 1. A top maintenance cover (not shown) has been removed from router 104 for illustrative purposes. The router 104 includes an enclosure 202 that protects the internal components from external environmental hazards. In one example, the enclosure 202 complies with EN50155 standards for railway and meets specific electromagnetic, fire, and shock capabilities. The enclosure 202 comprises any suitable material for complying with the EN50155 railway standard.

The router 104 integrates a server 204 with a cellular gateway 206 into a single device that can be easily deployed and maintained to provide Internet access to one or more computing devices 106 and 108. To facilitate communication, the router 104 includes several ports and interfaces on a front panel 208 as well as a rear panel (not shown).

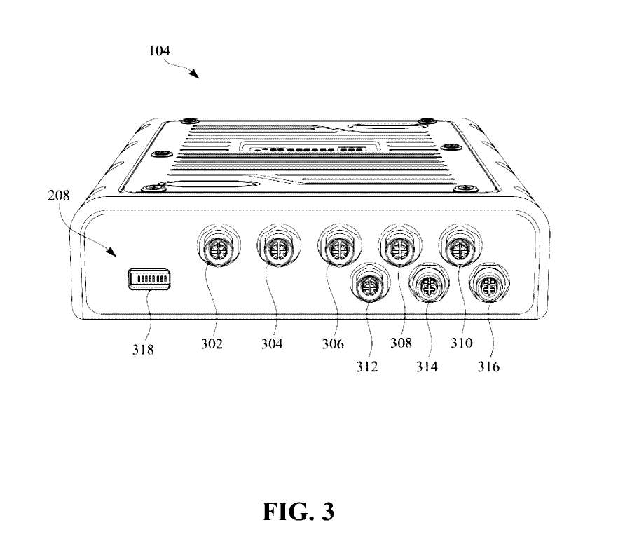

FIG. 3 illustrates the front panel 208 of the router 104 in more detail. The front panel 208 includes 6 Gigabit Ethernet ports 302, 304, 306, 308, 310, and 312. It should be appreciated that although Gigabit Ethernet ports are illustrated, the Ethernet ports 302-312 may be 10 mbps, 100 mbps, or other suitable transmission rates. In one example, the Ethernet ports 302-312 may vary in transmission rates while in another example, as illustrated, the Ethernet ports may all be the same. In one example, the Ethernet ports 302-312 are M12 X-code 8-way sockets.

The front panel 208 further includes a first console port 314 for enabling configuration of the server 204. The front panel 208 further includes a second console port 316 for enabling configuration of the cellular gateway 206. In one example, the first and second console ports 314 and 316 are M12 D-Code 4-way sockets.

The front panel further includes a removable storage port 318 for enabling router configurations to be easily installed, removed, updated, and swapped. In one example, the removable storage port is a USB port.

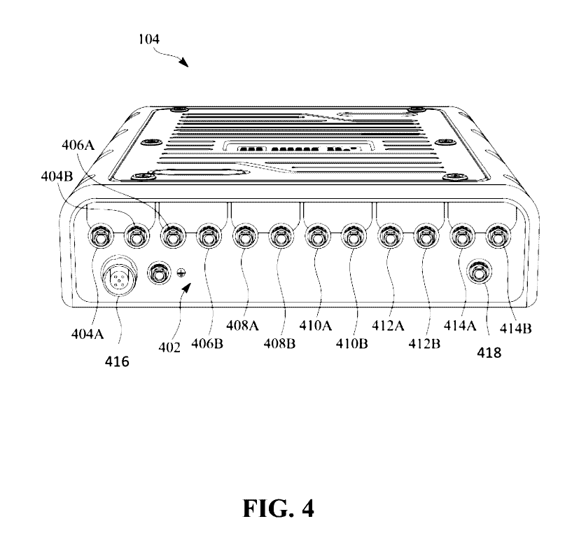

FIG. 4 illustrates a rear panel 402 of the router 104. The rear panel 402 includes multiple pairs of RF interface antenna ports 404A-B, 406A-B, 408A-B, 410A-B, 412A-B, and 414A-B. Each of the pairs of antenna ports 404-414 corresponds to a modem card (not shown). Each pair 404-414 includes a primary RF interface 404A-414A that supports both transmitting and receiving communications and also includes a secondary RF interface 404B-414B that only supports receiving communications. In one example, the interface ports 404-414 are SMA female antenna ports. The rear panel 402 further includes a power port 416 and a GPS port 418.

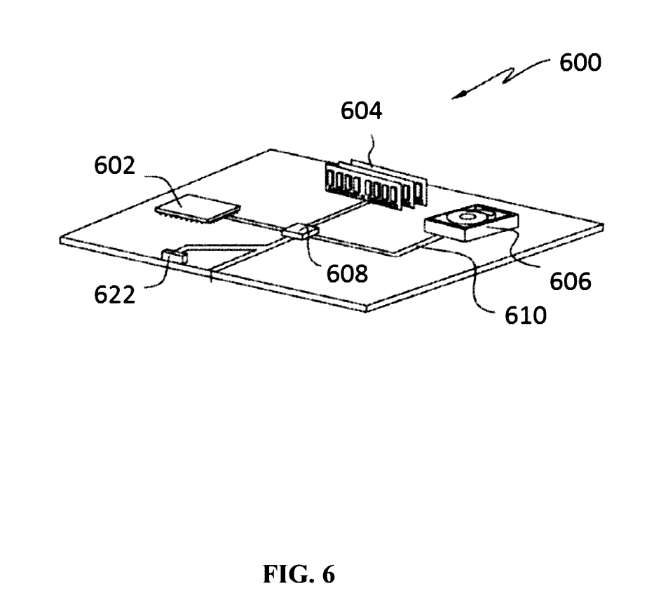

FIG. 6 illustrates a block diagram of the router 104. The router 104 includes 6 modems 502 to communicate and receive data and provide Internet access over a wireless network. It should be appreciated that although six modems 502 are illustrated, the router 104 may support any suitable number of modems. In one example, the modems 502 are removable and can be accessed by removing a maintenance cover (not shown). In particular, if the router 104 travels across multiple geographic regions, the same modems 502 may not support all networks across the multiple regions. Therefore, appropriate modems 502 that correspond to present geographic regions may be swapped in.

In one example, the modems 502 may be dual SIM MPCI-L200 modem cards. The modems 502 may support suitable communication standards including multi-band LTE-FDD, HSPA+, and GPRS/EDGE. In one example, the modems 502 have an industry standard form factor such as a PCI Express Mini Card form factor. The modems 502 include two antenna RF antennas (not shown). In particular, a primary or main RF antenna supports both transmitting and receiving data while a secondary RF antenna supports receiving data only. The two antennas may be interfaced via RF interface antenna ports 404A-B, 406A-B, 408A-B, 410A-B, 412A-B, and 414A-B illustrated in FIG. 4.

In one example, modem swapping may not be required when the router 104 moves between different geographic regions. Rather, the router 104 may detect a current location and automatically utilize the appropriate modem 502 that corresponds to a network associated with the current location.

The router 104 further includes a cellular gateway 504 for routing data traffic between the router 104 and the Internet via the modems 502. The cellular gateway 504 includes a switch 506 to help direct the path of the data being transmitted via the router 104. In one example, the cellular gateway 504 interfaces with the modems 502 via USB.

The router 104 further includes a server 508 for hosting and executing router software. In particular, the server 508 includes a primary operating system 510 for providing networking and communications functionality for the router 104. In one example, primary operating system 510 may be a Cisco operating system such as Cisco IOS 5921. The primary operating system 510 leverages a Linux platform (not shown) provided by the server 508.

A primary router operating system 510, such as Cisco IOS, however, relies on the Linux platform to provide Ethernet connectivity only and is not capable of facilitating router communication over non-Ethernet connections. Thus, server 508 further includes a secondary operating system 512 to extend the functionality of the primary operating system 510 and to provide a communication interface to non-Ethernet connections.

The secondary operating system 512 runs on a virtual machine 514 monitored by hypervisor 516. In order to extend the functionality of the primary operating system 510, the secondary operating system 512 acts as an intermediary in between the primary operating system 510 and the underlying Linux platform. In particular, the secondary operating system 512 is configured to interpret and translate data and commands that the primary operating system 510 would otherwise not be capable of understanding. For example, the secondary operating system 512 is configured to interpret an SSID or an encryption key and to convert it to a data format that is understandable by the primary operating system 510. Thus, by acting as an intermediary, the secondary operating system 512 is able to add Wi-Fi capabilities to the primary operating system 510 and, in turn, allow the router 104 to serve as a Wi-Fi access point.

In one example, the primary operating system 510 may be configured so as not to run in a virtualized environment. Accordingly, in order to extend the capabilities of the primary operating system 510, the secondary operating system 512 may be configured to bypass the virtualization protection of the primary operating system 510. In particular, the secondary operating system 512 may be configured to intercept and examine system function calls. If the function call is looking for indications of a virtualized environment, then an appropriate value will be returned. Otherwise, the function call will be passed through without any change.

In order to facilitate the secondary operating system 512 extending the primary operating system 510, interfaces (not shown) of the primary operating system 510 are mapped to interfaces of the secondary operating system 512. The interfaces are mapped automatically by the secondary operating system 512 during boot up. The mapped interfaces may include a combination of real Ethernet interfaces and interfaces dedicated for internal communications between the primary operating system 510 and the secondary operating system 512. For example, a Cisco 5921 operating system that supports up to 12 interfaces (in three slots of four interfaces) may be mapped as illustrated in Table 1.

TABLE 1

| KlasOS4 | Cisco 5921 | Linux |
|---|---|---|
| Ethernet 0/0 | Ethernet 0/0 | ethx (lowest mac address) |
| Ethernet 0/1 | Ethernet 0/1 | ethx |
| Ethernet 0/2 | Ethernet 0/2 | ethx |
| Ethernet 0/3 | Ethernet 0/3 | ethx |
| Ethernet 1/0 | Ethernet 1/0 | ethx |
| Ethernet 1/1 | Ethernet 1/1 | ethx |
| Ethernet 1/2 | Ethernet 1/2 | ethx |
| Ethernet 1/3 | Ethernet 1/3 | ethx (highest mac address) |
| Ethernet 2/0 | Ethernet 2/0 | tap0 |
| Ethernet 2/1 | Ethernet 2/1 | tap1 |
| Ethernet 2/2 | Ethernet 2/2 | tap2 |
| Ethernet 2/3 | Ethernet 2/3 | tap3 |

It should be appreciated that the secondary operating system 512 may serve to extend the primary operating system's 510 capabilities in additional ways. For example, the secondary operating system 512 may enable the router 104 to support additional features such as cellphone tethering, Harris radio tethering, synchronous serial communication, and VoIP.

It should also be appreciated that although the virtual machine 514 is illustrated as hosting the secondary operating system 512, the virtual machine may also host other suitable software applications such as call management software and WAN acceleration software, as well as entertainment and advertising software, for example, in order to maximize hardware resources.

In one example, the router 104 is configured to interface with a removable storage device 518 via the removable storage port 318 illustrated in FIG. 3. The removable storage device 518 includes router configuration information. In one example, the removable storage device 518 has a USB interface.

Upon inserting the portable storage device 502 into the removable storage port 318, the cellular gateway 504 mounts the removable storage device 518 and makes the contents of the removable storage device 518 available to the router 104. Thus, the router 104 can be easily configured and reconfigured by swapping out the removable storage device 518 with one that has an alternate configuration. For example, when changes to the external network require changes to the router 104 configuration, this can be easily accomplished by swapping in a new removable storage device 518 with updated configuration data. Similarly, if the router 104 malfunctions or fails, the removable storage device 518 may be removed and inserted into a replacement router 104 without having to reconfigure the replacement router 104.

In one example, the primary operating system 510 is configured to transfer the configuration data from the mounted removable storage device 518 at boot time. For example, the primary operating system 510 may use Trivial File Transfer Protocol (“TFTP”) or another suitable protocol to transfer the configuration data. Configuration data is necessary for the primary operating system 510, and, in turn, for the router 104 to function. Without the configuration data, the router 104 will be inoperable. Accordingly, the removable storage device 518 serves as an ignition key wherein the router 104 will not boot up with the removable storage device 518 first being inserted. Similarly, the router 104 will shut down if the removable storage device 518 is removed during operation.

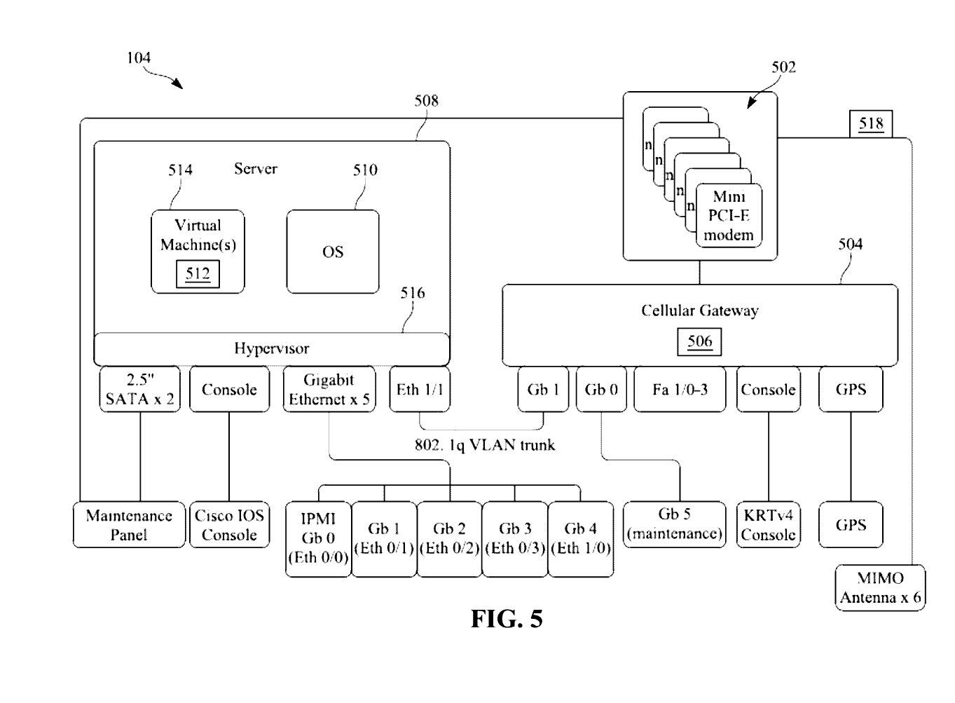

FIG. 6 is a schematic diagram of an example computer for implementing the example server 204 of FIG. 5. Computer 600 includes a processor 602, memory 604, a storage device 606, and a communication port 622, operably connected by an interface 608 via a bus 610.

Processor 602 processes instructions, via memory 604, for execution within computer 600. In an example embodiment, multiple processors along with multiple memories may be used. In one example, the processor 602 includes a COM Express CPU module supporting Intel Core i7 Sandy Bridge and Ivy Bridge architectures. In one example, the processor 602 includes an Intel Core i7-2610UE processor.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, optical disk device, a tape device, a flash memory, phase change memory, or other similar solid state memory device, or an array of devices, including devices in a storage area network of other configurations. In one example, the storage device 606 includes dual solid state disk drives. A computer program product can be tangibly embodied in a computer-readable medium such as memory 604 or storage device 606.

While example systems, methods, and so on have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art, Therefore, the invention is not limited to the specific details and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Gamer, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. An integrated access router comprising:
a modem for communicating with a wireless network;
a cellular gateway, comprising a switch, for routing data via the modem; and
a server comprising one or more processors, one or more computer-readable tangible storage devices, and program instructions stored on at least one of the one or more storage devices for execution by at least one of the one or more processors, the program instructions comprising:
a primary networking operating system for providing networking and communication capabilities via an Ethernet connection; and
a secondary networking operating system for extending the capabilities of the primary operating system and providing networking and communication capabilities via a non-Ethernet connection by serving as an intermediary between the primary networking operating system and an underlying server operating system.

2. The integrated access router of claim 1, wherein the cellular gateway is configured to interface with a removable storage device and mount the removable storage device such that router configuration data stored on the removable storage device is accessible by the server; and
wherein the primary networking operating system is configured to retrieve the router configuration data from the removable storage device when initializing.

3. The integrated access router of claim 2, wherein the integrated access router is inoperable while the cellular gateway is not interfacing with the removable storage device.

4. The integrated access router of claim 2, wherein the cellular gateway is configured to interface with the removable storage device via a USB interface.

5. The integrated access router of claim 1, wherein networking and communication capabilities via a non-Ethernet connection comprises the integrated access router functioning as a wireless access point.

6. The integrated access router of claim 1, wherein networking and communication capabilities via a non-Ethernet connection comprises one of cellphone tethering, Harris radio tethering, synchronous serial communication, and VoIP.

7. The integrated access router of claim 1, wherein the underlying server operating system comprises Unix and the primary networking operating system comprises Cisco IOS.

8. The integrated access router of claim 1, further comprising a plurality of modems for communications with a plurality of wireless networks, wherein the cellular gateway is configured to automatically switch to one of the plurality of modems based on a network associated with a detected current geographic region.

9. The integrated access router of claim 1, wherein the program instructions further comprise a virtual machine for executing the secondary networking operating system and a hypervisor for monitoring the virtual machine.

10. The integrated access router of claim 9, wherein the virtual machine is further configured to execute one of call management software and WAN acceleration software.

11. A computer program product comprising one or more computer-readable tangible storage devices, and program instructions stored on at least one of the one or more storage devices, the program instructions comprising:
a primary networking operating system for providing networking and communication capabilities via an Ethernet connection; and
a secondary networking operating system for extending the capabilities of the primary operating system and providing networking and communication capabilities via a non-Ethernet connection by serving as an intermediary between the primary networking operating system and an underlying server operating system.

12. The computer program product of claim 11, wherein the primary networking operating system is configured to retrieve router configuration data from a removable storage device during initialization.

13. The computer program product of claim 12, wherein the primary networking operating system is configured to be inoperable responsive to being unable to retrieve router configuration data from the removable storage device.

14. The computer program product of claim 11, wherein networking and communication capabilities via a non-Ethernet connection comprises wireless access point functionality.

15. The computer program product of claim 11, wherein networking and communication capabilities via a non-Ethernet connection comprises one of cellphone tethering, Harris radio tethering, synchronous serial communication, and VoIP.

16. The computer program product of claim 11, wherein the underlying server operating system comprises Unix and the primary networking operating system comprises Cisco IOS.

17. The computer program product of claim 11, wherein the program instructions further comprise a virtual machine for executing the secondary networking operating system and a hypervisor for monitoring the virtual machine.

18. The computer program product of claim 17, wherein the virtual machine is further configured to execute one of call management software and WAN acceleration software.

19. A system for routing network data, the system comprising one or more processors, one or more computer-readable tangible storage devices, and program instructions stored on at least one of the one or more storage devices for execution by at least one of the one or more processors, the program instructions comprising:
a primary networking operating system for providing networking and communication capabilities via an Ethernet connection; and
a secondary networking operating system for extending the capabilities of the primary operating system and providing networking and communication capabilities via a non-Ethernet connection by serving as an intermediary between the primary networking operating system and an underlying server operating system.

20. The system of claim 19, wherein the primary networking operating system is configured to retrieve configuration data from a removable storage device during initialization.
